(19) United States
(12) Patent Application Publication
(10) Pub. No.: US 2015/0355803 A1
(43) Pub. Date: Dec. 10, 2015

(54) OPERATION UNIT-EQUIPPED DEVICE, COMPUTER PROGRAM PRODUCT, AND INFORMATION PROCESSING METHOD

(71) Applicants: Hiroyuki TANAKA, Fukuoka (JP); Kentarou OHGA, Tokyo (JP); Mantaroh YOSHINAGA, Tokyo (JP)

(72) Inventors: Hiroyuki TANAKA, Fukuoka (JP); Kentarou OHGA, Tokyo (JP); Mantaroh YOSHINAGA, Tokyo (JP)

(21) Appl. No.: 14/729,263

(22) Filed: Jun. 3, 2015

(30) Foreign Application Priority Data
Jun. 5, 2014 (JP) 2014-117108

(51) Int. Cl. G06F 3/0484

(52) U.S. Cl. CPC G06F 3/0484

(57) ABSTRACT

An operation unit-equipped device includes an operation unit. The operation unit includes a property controller configured to store, in a storage unit, operation property information of an application for controlling a main body of the operation unit-equipped device or changed information that is a changed piece of the operation property information; and a control unit. The control unit is configured to control, when the changed information is stored in the storage unit, an operation of the main body by an operation of the application corresponding to the changed information. The control unit is also configured to control, when the changed information is not stored in the storage unit, an operation of the main body by an operation of the application corresponding to the operation property information.

### CROSS-REFERENCE TO RELATED APPLICATION

The present application claims priority to and incorporates by reference the entire contents of Japanese Patent Application No. 2014-117108 filed in Japan on Jun. 5, 2014.

### BACKGROUND OF THE INVENTION

1. Field of the Invention

The present invention relates to an operation unit-equipped device, a computer program product, and an information processing method.

2. Description of the Related Art

In recent years, a manufacturer that manufactures a device such as an MFP (Multifunction Peripheral) provided with a plurality of image forming functions has opened a source code of a platform of the device, for example. A developer of a platform generally extends, replaces, or reuses the opened source code to develop an application of the device.

In general, it is necessary in developing an application for controlling a device to give a description of a lot of inherent source codes. It is also necessary to entirely grasp a state transition and an interface specification (I/F specification) of the device. There is therefore a problem of requiring a lot of time and effort in the development.

Therefore, there is a need for an operation unit-equipped device, a computer program product, and an information processing method which are capable of developing an application for a device more easily.

### SUMMARY OF THE INVENTION

It is an object of the present invention to at least partially solve the problems in the conventional technology.

According to an embodiment, there is provided an operation unit-equipped device that includes an operation unit. The operation unit includes a property controller configured to store, in a storage unit, operation property information of an application for controlling a main body of the operation unit-equipped device or changed information that is a changed piece of the operation property information; and a control unit. The control unit is configured to control, when the changed information is stored in the storage unit, an operation of the main body by an operation of the application corresponding to the changed information. The control unit is also configured to control, when the changed information is not stored in the storage unit, an operation of the main body by an operation of the application corresponding to the operation property information.

According to another embodiment, there is provided a computer program product for being executed on a computer. The computer includes a property controller configured to store, in a storage unit, operation property information of an application for controlling a main body of the operation unit-equipped device or changed information that is a changed piece of the operation property information; and a control unit. The control unit is configured to control, when the changed information is stored in the storage unit, an operation of the main body by an operation of the application corresponding to the changed information. The control unit is also configured to control, when the changed information is not stored in the storage unit, an operation of the main body by an operation of the application corresponding to the operation property information.

According to still another embodiment, there is provided an information processing method that includes: storing, by a property controller, in a storage unit, operation property information of an application for controlling a main body or changed information that is a changed piece of the operation property information; controlling, by a control unit, when the changed information is stored in the storage unit, an operation of the main body by an operation of the application corresponding to the changed information; and controlling, by the control unit, when the changed information is not stored in the storage unit, an operation of the main body by an operation of the application corresponding to the operation property information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 illustrates a hardware configuration of an MFP according to an embodiment;

FIG. 2 illustrates a module configuration of an application development system (app development system) provided at an operation unit side of the MFP according to the embodiment;

FIG. 3 is a flowchart of a flow in customizing operation parameters (properties) in a device control framework provided at the operation unit side of the MFP according to the embodiment;

FIG. 4 is a flowchart of a flow in customizing a screen component in the device control framework provided at the operation unit side of the MFP according to the embodiment;

FIG. 5 is a flowchart of a flow of a registering operation of a post-processing in the device control framework provided at the operation unit side of the MFP according to the embodiment;

FIG. 6 is a schematic view of a property controller, a screen display controller, and a post-processing controller which are registered in the device control framework provided at the operation unit side of the MFP according to the embodiment; and

FIG. 7 is a flowchart of a flow of a control operation of a main body of the MFP in an operation controller of the device control framework provided at the operation unit side of the MFP according to the embodiment.

### DETAILED DESCRIPTION OF THE PREFERRED EMBODIMENTS

For example, Japanese Laid-open Patent Publication No. 2013-143125 discloses a mobile content development platform that creates in advance a program code for an execution of a particular function with an application designed for a smartphone and is provided to a third vendor. The mobile content development platform enables easily developing an application for a smartphone. Besides, the mobile content development platform enables shortening a period of the development. Even such a development platform, however, requires a lot of time and effort in the development. In addition, when a framework corresponding to a series of operations of the device is provided, it is difficult to change (customize) a default value for operation parameters (properties) or a screen layout to a desired value.

An MFP (Multifunction Peripheral) according to an embodiment to which an operation unit-equipped device, an information processing system, a computer program product with an information processing program, and an information processing method are applied will be explained in detail below with reference to the accompanying drawings. Here, an MFP is an electronic device including at least one of functions among a printing function, a copying function, a scanner function, and a facsimile function, for example. Besides, an application for electronic devices such as a projector, a teleconference system, and a digital camera device, even other than the MFP, may be developed.

Brief Overview

An MFP according to the embodiment uses a device control framework to enable a development of an application for an MFP, for example. The device control framework provides an “operation control function”, a “property control function”, a “screen display control function”, and a “post-processing control function”.

The “operation control function” provides a function of controlling a series of preset operations in controlling a main body of the MFP via a WebAPI. Here, Web is an abbreviation for “World Wide Web”. Besides, API is an abbreviation for “Application Programming Interface”. The “property control function” provides, as a default value, a combination of operation parameters (properties) whose usage frequency is high. The “property control function” enables customizing a default value by defining the default value as an external file.

The “screen display control function” is a function of controlling screens to be displayed during a control of the device. The screens during the control of the MFP are likely to have layouts similar to each other. Therefore, the “screen display control function” provides a screen of a preset default value as a screen during the control. An application developer is allowed to customize the screen layout by specifying an XML that defines the screen layout. Here, XML is an abbreviation for “eXtensible Markup Language”. Through an association with operation parameters (properties) in a form of an addition to a screen component, customizing the screen component is enabled.

The MFP performs a processing of distributing or storing, after generating, an electronic document. Such a post-processing has a lot of connections with a business logic. Therefore, a user is allowed to define a desired post-processing by the “post-processing control function”. The user registers a processing defined by the XML. The registered post-processing is thus executed by the framework.

As explained, the MFP according to the embodiment, whose control part is simplified for a developer of an application, provides a framework that enables customizing a desired property or a screen layout.

### Embodiment

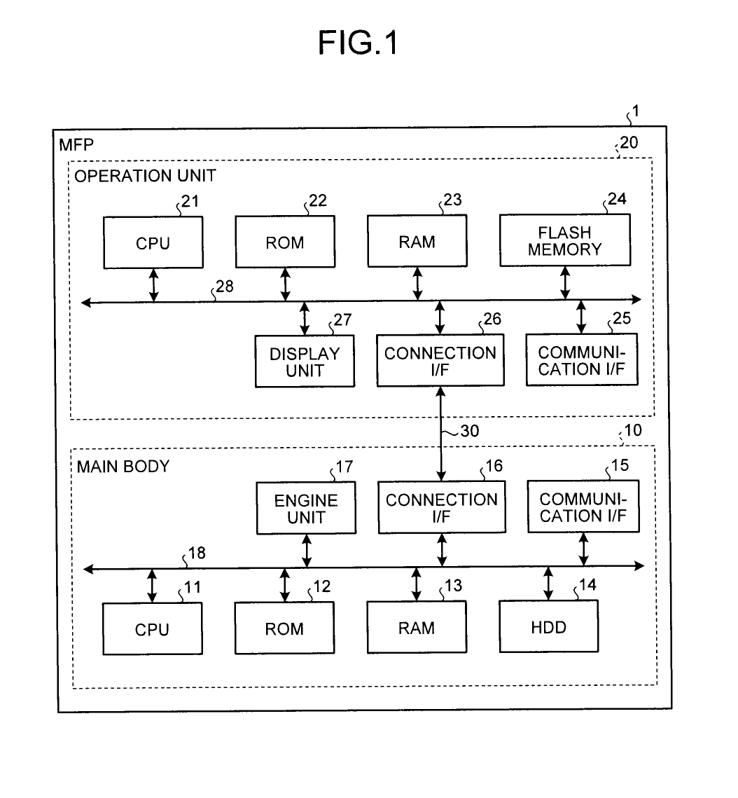

FIG. 1 illustrates a hardware configuration of an MFP according to an embodiment. An MFP 1 is provided with a main body 10 having a variety of functions including a copying function, a scanner function, a facsimile function, and a printing function and an operation unit 20 that receives an input appropriate to an operation by a user.

The operation unit 20 is detachable from the main body 10 of the MFP 1. The operation unit 20, when attached to the main body 10, mutually communicates with the main body 10 via a dedicated communication channel 30. For the communication channel 30, a USB (Universal Serial Bus) standard may be used, for example. The operation unit 20, when detached from the main body 10, performs a wireless communication with the main body 10 via the WebAPI. The operation unit 20, when detached from the main body 10, may perform a wireless communication such as the Bluetooth® communication or an infrared communication with the main body 10. In the operation unit 20, various applications operating on the main body 10 of the MFP 1, an operation screen of the application being developed by a developer, and the like are displayed. The operation unit 20 thus functions as an operation unit of the MFP 1. An information processing terminal as an electronic device, such as a tablet terminal and a smartphone, capable of independently executing a complete information processing may be used as the operation unit 20, for example.

More specifically, the information processing terminal used as the operation unit 20 is detachably connected to the main body 10, instead of a fixed operation panel arranged as an operation unit dedicated to the MFP 1. In other words, the information processing terminal used as the operation unit 20 is arranged integrally with the main body 10 while being detachable (separable) at a predetermined position such as a position where the operation panel of the main body 10 is arranged, for example. Therefore, the information processing terminal used as the operation unit 20 and the main body 10 may be recognized as one device.

The main body 10 operates in accordance with an input received from the operation unit 20. The main body 10 is enabled to communicate with an external device such as a client PC (personal computer) and to operate in accordance with an instruction received from the external device.

Next, a hardware configuration of the main body 10 will be explained. As illustrated in FIG. 1, the main body 10 is provided with a CPU 11, a ROM 12, a RAM 13, an HDD (Hard Disk Drive) 14, a communication I/F (interface) 15, a connection I/F 16, and an engine unit 17. The CPU 11 to the engine unit 17 are connected to each other via a system bus 18.

The CPU 11 totally controls an operation of the main body 10. The CPU 11 uses the RAM 13 as a work area (work space) and executes application programs stored in the ROM 12 or the HDD 14. With this configuration, the CPU 11 controls the entire operation of the main body 10 and realizes various functions including the copying function, the scanner function, the facsimile function, and the printing function.

The communication I/F 15 is an interface that enables a communication with an external device such as a client PC (personal computer). The connection I/F 16 is an interface that enables a communication with the operation unit 20 via the communication channel 30. While the communication channel 30 is illustrated with wire in FIG. 1, the operation unit 20 is provided by being detachably attached to the main body 10 of the MFP 1 as explained above. Therefore, it is preferable to understand that the communication channel 30 functions as a wired communication channel when the operation unit 20 is attached to the MFP 1 and functions as a wireless communication channel when the operation unit 20 is detached from the MFP 1.

The engine unit 17 is a hardware that performs a processing, except for a versatile information processing and communication, for realizing the copying function, the scanner function, the facsimile function, and the printing function. For example, the engine unit 17 is provided with a scanner (image reading unit) that scans and reads out an image of a document, a plotter (an image forming unit) that performs printing onto a sheet member such as paper, a facsimile unit that performs a facsimile communication, and the like. The engine unit 17 may further be provided with special options such as a finisher that sorts printed sheet members and an ADF (Automatic Document Feeder) that automatically feeds a document.

Next, a hardware configuration of the operation unit 20 will be explained. As illustrated in FIG. 1, the operation unit 20 is provided with a CPU 21, a ROM 22, a RAM 23, a flash memory 24, a communication I/F 25, a connection I/F 26, and a display unit 27. The CPU 21 to the display unit 27 are connected to each other via a system bus 28.

The CPU 21 totally controls an operation of the operation unit 20. The CPU 21 uses the RAM 23 as a work area (work space) and executes programs stored in the ROM 22 or the flash memory 24. With this configuration, the CPU 21 controls the entire operation of the operation unit 20 and then realizes various functions, which will be explained later, including a display of information (image) in accordance with an input received from a user.

The communication I/F 25 is an interface that enables a communication with a Web server device via a network. Besides, the communication I/F 25 is an interface that enables a communication with the main body 10 through a wireless communication via the network when the operation unit 20 is detached from the main body 10. The connection I/F 26 is an interface that enables a communication with the main body 10 through a wired communication via the communication channel 30 when the operation unit 20 is attached to the main body 10.

The display unit 27 receives inputs of various kinds in accordance with operations by a user and displays information of various kinds, for example, information appropriate to the received input, information indicating an operational status of the MFP 1, and information indicating a setting state. For example, the display unit 27 is configured by a liquid crystal display (LCD) device equipped with a touch-screen function. The display unit 27 may have other configurations and may, for example, be configured by an organic EL display device equipped with a touch-screen function. Moreover, an operation unit such as a hardware key and a light emitting unit may be provided in the display unit 27.

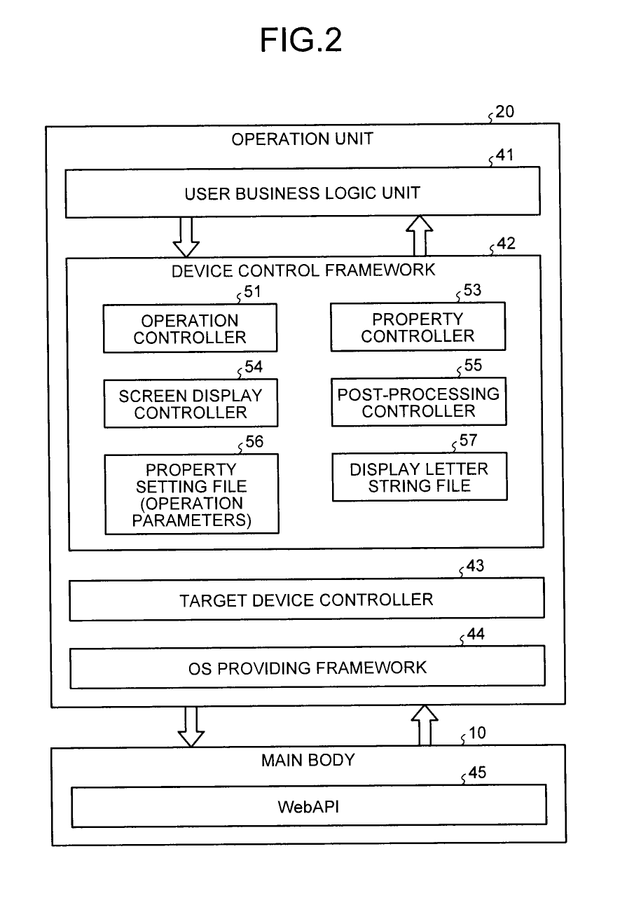

Next, FIG. 2 illustrates a module configuration of an application development system (app development system) provided at a side of the operation unit 20. The app development system is software stored in a storage unit such as the ROM 22, the RAM 23, or the flash memory 24 of the operation unit 20 illustrated in FIG. 1. The app development system is provided with a user business logic unit 41, a device control framework 42, a target device controller 43, and an OS providing framework 44. Here, OS is an abbreviation for “Operating System”.

The user business logic unit 41, which is an application developed by a developer, serves as a module that calls a target framework. The application of the user business logic unit 41 provides a UI function that allows an operation and a display concerning the copying function, the scanner function, the facsimile function, and the printing function provided in the main body 10, for example. Here, UI is an abbreviation for “User Interface”. The application of the user business logic unit 41 may be an application that causes a hardware resource provided in the operation unit 20 to operate to provide a predetermined function.

The device control framework 42 is a framework to be provided to a developer of an application by a manufacturer side of the MFP 1. The device control framework 42 constructs the application to be developed by the developer in the user business logic unit 41 while communicating with the target device controller 43 and the OS providing framework 44. The device control framework 42 is provided with an operation controller 51, a property controller 53, a screen display controller 54, and a post-processing controller 55. The operation controller 51 is an example of a control unit.

When the application of the user business logic unit 41 is activated, the property controller 53 is generated and registered in the operation controller 51. The property controller 53 is a control unit that controls operation parameters (an example of operation property information) of an application that causes a target device to operate. In the device control framework 42, a combination of operation parameters whose usage frequency is high is set as a default value (initial value) and provided as a property setting file 56. The developer of the application is able to easily specify desired operation parameters by changing the default value of the property setting file 56. The property controller 53 performs a control of storing changed operation parameters (example of changed information) in a storage unit such as the RAM 23 or the flash memory 24 together with a property name which is a letter string selected from a display letter string file 57 and a display name. By adding operation parameters as a property of a screen component such as a button and a label to be displayed in a screen, operation parameters and the screen components are associated.

Similarly, when the application of the user business logic unit 41 is activated, the screen display controller 54 is generated and registered in the operation controller 51. The screen display controller 54 is a control unit that controls a screen to be displayed during the control of the main body 10. Screens during the control of the MFP 1 are likely to have layouts similar to each other. Therefore, the developer is provided with a screen (initial screen) of a default value for the period during control from the manufacturer. The application developer is allowed to customize the screen layout by specifying an XML that defines the screen layout. The customized screen layout is an example of a defined screen. By adding operation parameters as a property of a screen component such as a button and a label to be displayed in the screen, operation parameters and the screen components are associated. The developer is enabled to customize a screen in operation, for example, of the target device by associating a desired screen component with desired operation parameters through the application.

The screen display controller 54 performs a control of storing information of the during-control screen (initial screen) of the default value provided from the manufacturer side in the storage unit such as the RAM 23 or the flash memory 24. Besides, the screen display controller 54 performs a control of storing information of the screen layout defined by the developer of the application in the storage unit such as the RAM 23 or the flash memory 24. The screen display controller 54 performs a control of storing the screen component and the operation parameters which are associated by the developer through the application in the storage unit such as the RAM 23 or the flash memory 24.

Next, the MFP 1 performs a processing of distributing or storing, after generating, an electronic document. Such a “post-processing” has a lot of connections with the business logic. When a post-processing defined by the XML is specified by the developer for example, the post-processing controller 55 is registered in the operation controller 51 in the device control framework 42. When a “post-processing” such as an OCR processing or a mail transferring processing after a processing of scanning a document is registered through the application for example, the post-processing controller 55 is generated and registered by the operation controller 51. The post-processing controller 55 then performs a control of storing information indicating this post-processing in the storage unit such as the RAM 23 or the flash memory 24. Here, OCR is an abbreviation for “Optical Character Recognition”. After a processing of printing or scanning at the side of the main body 10 is completed, for example, the operation controller 51 performs a control of executing the post-processing (post-processing registered by the developer) indicated by the post-processing controller 55.

The operation controller 51 controls the operation of the target device controller 43 in accordance with the registered property controller 53, screen display controller 54, and post-processing controller 55. When the default value of the operation parameters (properties) is not changed, the operation controller 51 controls the operation of the target device controller 43 with the default value of each property stored in the property setting file 56. The target device controller 43 controls the operations (processings) including the copying and the scanning of the main body 10 which is a control target via the WebAPI 45. The OS providing framework 44 is a basic control framework provided by the OS installed in the operation unit 20.

To maintain independence in function in the MFP 1 according to the embodiment, the OS used at the side of the main body 10 is different in kind from the OS used at the side of the operation unit 20 just in one instance. In other words, the main body 10 and the operation unit 20 are configured to independently operate with each other by separated operating systems. For example, the Linux® may be used for the OS at the side of the main body 10 and the Android® may be used for the OS at the side of the operation unit 20.

By operating the main body 10 and the operation unit 20 by separated operating systems in the MFP 1 according to the embodiment, the communication between the main body 10 and the operation unit 20 is performed not as an inter-process communication within a common device but as a communication between different devices. A transmission operation (command communication) of an input received by the operation unit 20 (a content instructed by a user) to the main body 10 and an operation, by the main body 10, of notifying the operation unit 20 of an event fall under this. Here, the function of the main body 10 can be used when the operation unit 20 performs a command communication with respect to the main body 10.

The event to be notified by the main body 10 to the operation unit 20 includes an execution status (the number of sheets whose printing are completed and the number of scanned sheets, for example) of the operation in the main body 10 and a content which is set at the side of the main body 10. The power is supplied to the operation unit 20 from the main body 10 via the communication channel 30. Therefore, it is possible to control a power source of the operation unit 20 separately (independently) from the control of the power source of the main body 10.

A part or all of the device control framework 42, the target device controller 43, and the OS providing framework 44 may be realized as hardware. Similarly, a part or all of the operation controller 51 and the property controller 53 to the post-processing controller 55 of the device control frame 42 may be realized as hardware.

While the property setting file 56 and the display letter string file 57 are illustrated on the assumption of being provided in an inside of the device control framework 42 in FIG. 2, the property setting file 56 and the display letter string file 57 may be provided in an outside of the device control framework 42, for example, in the inside of the user business logic unit 41, for example.

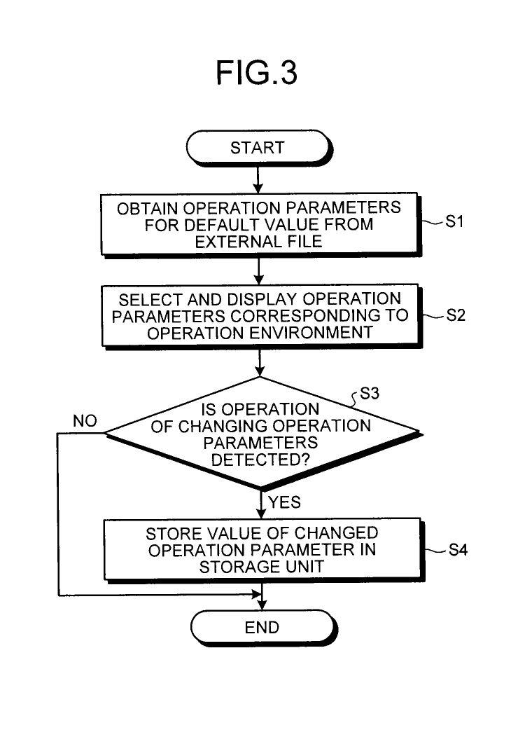

Next, a flow of customizing operation parameters (properties) of the device control framework 42 is illustrated in the flowchart in FIG. 3. When the application of the user business logic unit 41 is activated, the property controller 53 is generated and registered with respect to the operation controller 51. At step S1, the property controller 53 obtains respective operation parameters of the default value (initial value) stored in the property setting file 56 which is provided as an external file to cause the processing to go to step S2.

At step S2, the operation controller 51 selects operation parameters for an operation environment and a device setting of the MFP 1 from the obtained operation parameters and causes a list of the selected operation parameters to be displayed in the display unit 27. The developer of the application performs an operation of changing a value of a desired operation parameter among the displayed operation parameters through the application. At step S3, the operation controller 51 determines whether or not the operation, notified through the application, of changing operation parameters is present.

When determining that the operation of changing operation parameters is not detected (“No” at step S3), the operation controller 51 directly ends the processing of the flowchart in FIG. 3. In this case, the operation controller 51 and the target device controller 43 control the functions including the copying function, the scanner function, and the likes of the main body 10 with the operation parameters as the initial value.

On the other hand, when determining that the operation of changing operation parameters is detected (“Yes” at step S3), the operation controller 51 causes the processing to go to step S4. At step S4, the property controller 53 performs a control of storing the value of the changed operation parameter notified through the application in the storage unit such as the RAM 23 or the flash memory 24. The processing of the flowchart in FIG. 3 is then ended.

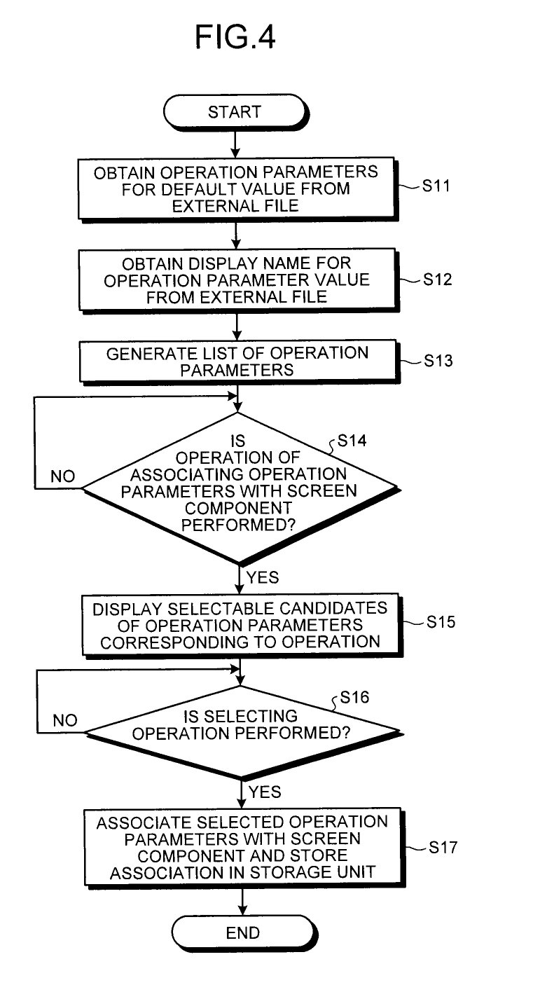

Next, a flow of customizing a screen component is illustrated in the flowchart in FIG. 4. Screens during the control of the MFP are likely to have layouts similar to each other. Therefore, a screen of a preset default value is provided as a during-control screen. The developer of the application is allowed to customize the screen layout by specifying an XML that defines the screen layout. Through an association with operation parameters (properties) in a form of an addition to a screen component, customizing the screen component is enabled.

When the application of the user business logic unit 41 is first activated, the property controller 53 is generated and registered in the operation controller 51. At step S11, the property controller 53 obtains operation parameters of the default value (initial value) stored in the property setting file 56 provided as an external file and causes the processing to go to step S12.

At step S12, the operation controller 51 selects operation parameters for an operation environment and a device setting of the MFP 1 from the obtained operation parameters. The operation controller 51 obtains a display name of the selected operation parameters from the display letter string file 57. The operation controller 51 then generates information of a list of the operation parameters and causes the information to be displayed in the display unit 27 at step S13.

When the developer of the application specifies an association of desired operation parameters with a desired screen component such as a button or a label, the application notifies the operation controller 51 of the specification of the association. At step S14, the operation controller 51 monitors the presence/absence of the notification from the application. When receiving the notification from the application (“Yes” at step S14), the operation controller 51 causes the processing to go to step S15 and causes a plurality of operation parameters for the screen component selected by the developer to be displayed in the display unit 27 as selectable candidates for operation parameters to be associated.

A user selects operation parameters to be associated with the screen component from the displayed selectable candidates. Here, a concept of the “user” includes any one of an operator, a manipulator, a developer, and the likes. The application notifies the operation controller 51 of the screen component and the selected operation parameters (operation parameters to be associated with the screen component). The operation controller 51 monitors whether or not the notification from the application is present at step S16. When receiving the notification from the application, the operation controller 51 determines that desired operation parameters are selected by the user (“Yes” at step S16) and causes the processing to go to step S17.

At step S17, the screen display controller 54 registered in the operation controller 51 associates the selected operation parameters with the screen component notified from the application and stores the association in the storage unit such as the RAM 23 or the flash memory 24, and the processing of the flowchart in FIG. 4 is ended. It is thus possible to associate desired operation parameters with a desired screen component.

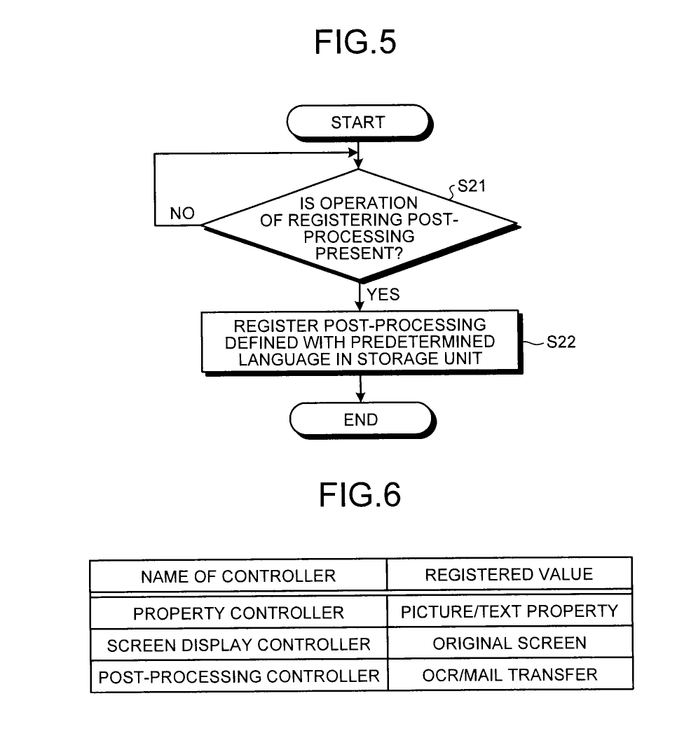

Next, a flow of an operation of registering a post-processing is illustrated in the flowchart in FIG. 5. The MFP 1 performs, after generating an electronic document or an electronic image, a processing (post-processing) of distributing or storing the generated electronic document or the like. Such a post-processing has a lot of connections with the business logic. The developer defines a post-processing with a processing language such as the XML and performs an operation of registering the defined post-processing through the application. At step S21, the operation controller 51 monitors whether or not the operation of registering a post-processing is present. When obtaining a request for registering a post-processing notified from the application and information of the post-processing defined by the XML (“Yes” at step S21), the operation controller 51 causes the processing to go to step S22.

At step S22, the post-processing controller 55 registered in the operation controller 51 performs a control of storing the post-processing defined by the XML in the storage unit such as the RAM 23 or the flash memory 24. The processing of the flowchart in FIG. 5 is thus ended. After a main processing such as a printing processing or a scanning processing is completed, the operation controller 51 performs a control of executing the post-processing registered by the post-processing controller 55.

FIG. 6 is a schematic view of the property controller 53, the screen display controller 54, and the post-processing controller 55 which are stored in the storage unit such as the RAM 23 or the flash memory 24. FIG. 6 illustrates an example in which a picture/text property is registered for the property controller 53, an original screen is registered for the screen display controller 54, and an OCR/mail transfer is registered for the post-processing controller 55. The operation controller 51 controls the functions of the main body 10 through the property controller 53 and the post-processing controller 55 as explained below. The operation controller 51 controls a screen display of the display unit 27 of the operation unit 20 through the screen display controller 54.

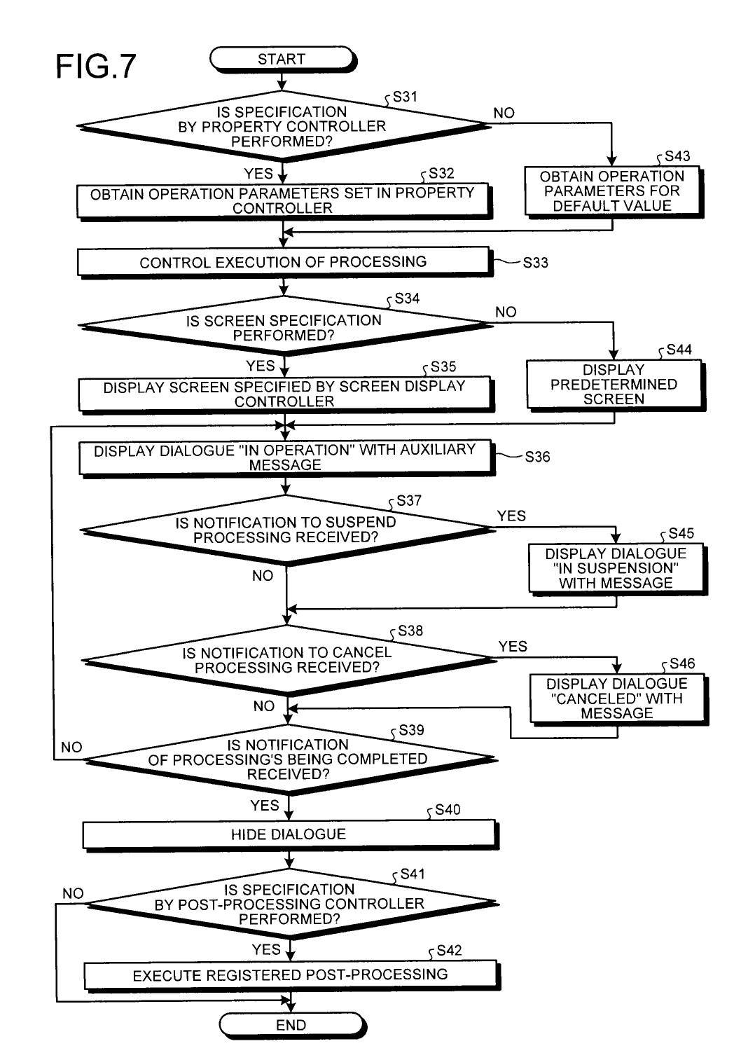

A flow of a control operation of the main body 10 by the operation controller 51 is illustrated in FIG. 7. In the flowchart in FIG. 7, when the application of the user business logic unit 41 is activated and a control of starting a scanning of a document is specified, the operation controller 51 determines whether or not operation parameters are specified by the property controller 53 at step S31.

When determining that operation parameters are not specified (“No” at step S31), the operation controller 51 causes the processing to go to step S43. At step S43, the operation controller 51 obtains operation parameters for the default value stored in the property controller 53. The operation controller 51 then controls the scanner function and the like of the main body 10 through the target device controller 43 to execute the processing such as a scanning or a printing with the operation parameters for the default value at step S33.

On the other hand, when determining that operation parameters are specified (“Yes” at step S31), the operation controller 51 causes the processing to go to step S32. At step S32, the operation controller 51 obtains the operation parameters set by the developer (see FIG. 6). The operation controller 51 then passes, to the target device controller 43, the operation parameters set by the developer instead of (by hiding) the operation parameters for the default value which are essentially supposed to be passed to the target device controller 43 at step S33. The target device controller 43 controls the scanner function and the like of the main body 10 to execute the processing such as a scanning or a printing with the operation parameters set by the developer.

Next, when the processing such as a scanning or a printing is started at the side of the main body 10, the operation controller 51 determines whether or not a screen to be displayed during the operation of the main body 10 is specified at step S34. Specifically, the operation controller 51 determines the presence/absence of a screen which is controlled and stored by the screen display controller 54 and changed by the developer.

When determining that a screen specified by the developer is not stored (“No” at step S34), the operation controller 51 causes the processing to go to step S44. At step S44, the operation controller 51 performs a control of displaying a predetermined in-operation screen, like the number of sheets whose printing are completed or the number of sheets whose scanning are completed, in the display unit 27.

On the other hand, when determining that a screen specified by the developer is stored (“Yes” at step S34), the operation controller 51 causes the processing to go to step S35. At step S35, the operation controller 51 performs a control of displaying an in-operation screen stored in the screen display controller 54 in the display unit 27. The in-operation screen customized by the developer is thus displayed.

Next, the operation controller 51 communicates with the CPU 11 of the main body 10 while controlling the operation of the main body 10 and updates the display screen displayed in the display unit 27 depending on an operation status of the main body 10 at step S36. Specifically, the operation controller 51 performs a control of displaying a dialogue “in operation” together with an auxiliary message like “10th page in printing”, for example during in the operation of the main body 10.

While controlling the operation of the main body 10, the operation controller 51 communicates with the CPU 11 of the main body 10 to monitor “the presence/absence of a notification to suspend the processing”, “the presence/absence of a notification to cancel the processing”, and “the presence/absence of a notification of the processing's being completed” from the main body 10, respectively at steps S37, S38, and S39.

When receiving the “notification to suspend the processing” from the main body 10 at step S37 (“Yes” at step S37), the operation controller 51 causes the processing to go to step S45. The operation controller 51 then performs a control of displaying a dialogue “in suspension” together with a message like “print in suspension because of paper jam” in the display unit 27, for example, at step S45.

When receiving the “notification to cancel the processing” from the main body 10 at step S38 (“Yes” at step S38), the operation controller 51 causes the processing to go to step S46. At step S46, the operation controller 51 performs a control of displaying a dialogue “canceled” together with a message like “print cancelled because of trouble in print unit” in the display unit 27, for example.

Next, when the operation specified at the side of the main body 10 is completed, the “notification of the processing's being completed” is transmitted. When receiving the “notification of the processing's being completed” from the main body 10 at step S39 (“Yes” at step S39), the operation controller 51 causes the processing to go to step S40. At step S40, the operation controller 51 performs a control of hiding the dialogue “in operation” displayed in the display unit 27 so far, for example.

As explained, the operation controller 51 communicates with the CPU 11 of the main body 10 while controlling the operation of the main body 10 to monitor the “processing in suspension”, “processing canceled”, and “processing completed” of the main body 10. The operation controller 51 then updates the display screen of the display unit 27 depending on the operational status of the main body 10.

Next, when the operation of the main body is completed, the operation controller 51 causes the processing to go to step S41 and determines whether or not a post-processing which is controlled and stored by the post-processing controller 55 is specified. When determining that the post-processing is not specified (“No” at step S41), the operation controller 51 directly ends the processing in the flowchart of FIG. 7. On the other hand, when determining that the post-processing is specified (“Yes” at step S41), the operation controller 51 causes the processing to go to step S42. The operation controller 51 then controls the main body 10 through the target device controller 43 to execute the post-processing such as an OCR or a mail transfer as already explained with reference to FIG. 6, for example and ends the processing in the flowchart of FIG. 7.

As is clear from the explanation so far, the MFP 1 according to the embodiment provides a developer of an application with a predetermined control procedure as the device control framework 42. Thus, it is possible for the developer to easily implement a series of predetermined control procedure and more easily develop an application without grasping the specification in detail of the MFP 1.

Besides, a string of operation parameters (properties), a screen layout of a display screen, and a post-processing are enabled to be defined, as an external file, respectively by the property controller 53, the screen display controller 54, and the post-processing controller 55. It is therefore possible to freely customize the string of operation parameters (properties), the screen layout of the display screen, and the post-processing.

The device control framework 42, the target device controller 43, and the OS providing framework 44 may be provided by being recorded in a file of an installable format or of an executable format in a computer-readable recording medium such as a CD-ROM and a flexible disk (FD). The device control framework 42, the target device controller 43, and the OS providing framework 44 may be provided by being recorded in a computer-readable recording medium such as a CD-R, a DVD, and a Blu-ray Disk® semiconductor memory, as a computer program product. Here, DVD is an abbreviation for a “digital versatile disk”. The device control framework 42, the target device controller 43, and the OS providing framework 44 may be provided in a form of being installed via a network such as the Internet. Besides, the device control framework 42, the target device controller 43, and the OS providing framework 44 may be provided by being preloaded in a ROM and the like in the device.

According to the embodiment, there is an advantage that it is possible to change a default value to a desired value and more easily develop an application for a device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An operation unit-equipped device comprising an operation unit including
a property controller configured to store, in a storage unit, operation property information of an application for controlling a main body of the operation unit-equipped device or changed information that is a changed piece of the operation property information; and
a control unit configured to
control, when the changed information is stored in the storage unit, an operation of the main body by an operation of the application corresponding to the changed information, and
control, when the changed information is not stored in the storage unit, an operation of the main body by an operation of the application corresponding to the operation property information.

2. The operation unit-equipped device according to claim 1, wherein
the operation unit further includes a screen display controller configured to store, in the storage unit, initial screen layout information indicating a predetermined initial screen layout or defined screen layout information indicating a defined screen layout,
the control unit displays, when the defined screen layout information is stored in the storage unit, a display screen indicated by the defined screen layout information on a display unit, and
the control unit displays, when the defined screen layout information is not stored in the storage unit, a display screen indicated by the initial screen layout information on the display unit.

3. The operation unit-equipped device according to claim 2, wherein
the screen display controller stores a screen component and the operation property information which are associated through the application in the storage unit, and
the control unit displays a display screen corresponding to the associated screen component and operation property information on the display unit.

4. The operation unit-equipped device according to claim 1, wherein
the operation unit further includes a post-processing controller configured to store post-processing information indicating a post-processing defined in the main body in the storage unit, and
the control unit controls the main body to perform the post-processing indicated by the post-processing information stored in the storage unit after an operation of the main body by the application is completed.

5. The operation unit-equipped device according to claim 1, wherein
the main body includes a Web application interface, and
the control unit communicates with the main body via the Web application interface to control the main body.

6. The operation unit-equipped device according to claim 1, wherein a combination of pieces of operation property information with high usage frequency is set for the operation property information as predetermined information or initial information.

7. A computer program product for being executed on a computer comprising:
a property controller configured to store, in a storage unit, operation property information of an application for controlling a main body or changed information that is a changed piece of the operation property information; and
a control unit configured to
control, when the changed information is stored in the storage unit, an operation of the main body by an operation of the application corresponding to the changed information, and
control, when the changed information is not stored in the storage unit, an operation of the main body by an operation of the application corresponding to the operation property information.

8. The computer program product according to claim 7, wherein
the computer further comprises a screen display controller configured to store, in the storage unit, initial screen layout information indicating a predetermined initial screen layout or defined screen layout information indicating a defined screen layout,
the control unit displays, when the defined screen layout information is stored in the storage unit, a display screen indicated by the defined screen layout information on a display unit, and
the control unit displays, when the defined screen layout information is not stored in the storage unit, a display screen indicated by the initial screen layout information on the display unit.

9. The computer program product according to claim 8, wherein
the screen display controller stores a screen component and the operation property information which are associated through the application in the storage unit, and
the control unit displays a display screen corresponding to the associated screen component and operation property information on the display unit.

10. The computer program product according to claim 7, wherein
the computer further comprises a post-processing controller configured to store post-processing information indicating a post-processing defined in the main body in the storage unit, and
the control unit controls the main body to perform the post-processing indicated by the post-processing information stored in the storage unit after an operation of the main body by the application is completed.

11. The computer program product according to claim 7, wherein
the main body includes a Web application interface, and
the control unit communicates with the main body via the Web application interface to control the main body.

12. The computer program product according to claim 7, wherein a combination of pieces of operation property information with high usage frequency is set for the operation property information as predetermined information or initial information.

13. An information processing method comprising:
storing, by a property controller, in a storage unit, operation property information of an application for controlling a main body or changed information that is a changed piece of the operation property information;
controlling, by a control unit, when the changed information is stored in the storage unit, an operation of the main body by an operation of the application corresponding to the changed information; and
controlling, by the control unit, when the changed information is not stored in the storage unit, an operation of the main body by an operation of the application corresponding to the operation property information.

14. The information processing method according to claim 13, further comprising:
storing, by a screen display controller, in the storage unit, initial screen layout information indicating a predetermined initial screen layout or defined screen layout information indicating a defined screen layout;
displaying, by the control unit, when the defined screen layout information is stored in the storage unit, a display screen indicated by the defined screen layout information on a display unit; and
displaying, by the control unit, when the defined screen layout information is not stored in the storage unit, a display screen indicated by the initial screen layout information on the display unit.

15. The information processing method according to claim 14, further comprising:
storing, by the screen display controller, a screen component and the operation property information which are associated through the application in the storage unit; and
displaying, by the control unit, a display screen corresponding to the associated screen component and operation property information on the display unit.

16. The information processing method according to claim 13, further comprising:
storing, by a post-processing controller, post-processing information indicating a post-processing defined in the main body in the storage unit; and
controlling, by the control unit, the main body to perform the post-processing indicated by the post-processing information stored in the storage unit after an operation of the main body by the application is completed.

17. The information processing method according to claim 13, wherein
the main body includes a Web application interface, and
the control unit communicates with the main body via the Web application interface to control the main body.

18. The information processing method according to claim 13, wherein a combination of pieces of operation property information with high usage frequency is set for the operation property information as predetermined information or initial information.
